(19) United States
(12) Patent Application Publication
(10) Pub. No.: US 2006/0098886 A1
(43) Pub. Date: May 11, 2006

(54) Efficient predictive image parameter estimation

(75) Inventor: Gerard De Haan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/541,414

(22) PCT Filed: Dec. 4, 2003
(86) PCT No.: PCT/IB03/05922

§ 371 Date: Jul. 1, 2005

(30) Foreign Application Priority Data
Jan. 10, 2003 (EP) 03075125.9

(51) Int. Cl. G06K 9/46

(52) U.S. Cl. 382/253

(57) ABSTRACT

The invention relates to a method for recursively estimating local vectors from at least one picture taken from an image sequence. To reduce the computational complexity of the estimation method without deteriorating its accuracy, it is proposed that the method comprises the steps of generating a first set of candidate vectors under at least partial use of recursion, selecting candidate vectors from the first set of candidate vectors according to a first criterion to form a smaller second set of candidate vectors, evaluating the candidate vectors of the second set of candidate vectors for a group of pixels based on a second criterion, determining the best vectors from the second set of candidate vectors according to said second criterion and assigning said determined best vectors to a group of pixels that is related to the group of pixels the candidate vectors of the second set of candidate vectors were evaluated for. The invention further relates to a device for recursively estimating local vectors from at least one picture taken from an image sequence, and to a computer program product comprising software code portions for recursively estimating local vectors from at east one picture taken from an image sequence.

The invention relates to a method for recursively estimating local vectors from at least one picture taken from an image sequence, comprising the steps of generating a first set of candidate vectors under at least partial use of recursion, selecting candidate vectors from the first set of candidate vectors according to a first criterion to form a smaller second set of candidate vectors, evaluating the candidate vectors of the second set of candidate vectors for a group of pixels based on a second criterion, determining the best vectors from the second set of candidate vectors according to said second criterion and assigning said determined best vectors to a group of pixels that is related to the group of pixels the candidate vectors of the second set of candidate vectors were evaluated for. The invention further relates to a device for recursively estimating local vectors from at least one picture taken from an image sequence, and to a computer program product comprising software code portions for recursively estimating local vectors from at least one picture taken from an image sequence.

Estimation of local vectors from image data is required for a broad range of image processing applications, such as coding/compression, noise reduction, object tracking and scan rate conversion. In a video coding framework such as MPEG or H.261, local vectors are represented by motion vectors that determine motion (or object displacement) from one image to another. Estimation of motion vectors can for instance be used for motion-compensated predictive coding. Since one picture in an image is normally very similar to a displaced copy of its predecessors, encoding estimated motion vector data together with information on the difference between the actual image and its prediction either in the pixel- or DCT-domain allows to vastly reduce the temporal redundancy in the coded signal.

Further examples for the estimation of local vectors comprise methods to segment an image in areas with similar spatial characteristics (object segmentation), where the local vectors then represent a quantitative measure for the spatial characteristics, and methods to estimate the motion model for image segments (objects), where the components of the local vectors then contain the parameters of the motion model.

State-of-the-art techniques to estimate local vectors from image data usually apply some kind of Block Matching Algorithm (BMA), where an image is decomposed in blocks of fixed or variable size. Quite as well, the image can be decomposed in its dominant objects instead of its blocks (object segmentation), so that the subsequent description equally well holds for objects instead of blocks. For each block of the current image, a similar block in the previous image is searched, where a similarity measure is applied to identify the previous block most similar to the current block. The local vector associated to the block of the previous image, for which the largest similarity was determined, then represents the local vector associated to the pixels of the current block. Note that, when calculating the similarity measure, not all pixels of the two blocks which are to be compared have to be evaluated. E.g., the blocks can be spatially sub-sampled, so that only each k-th pixel of both blocks is considered for the evaluation of the similarity measure.

To reduce the computational effort encountered when trying to check the similarity of the current block with all blocks in a previous image, local vectors are generally estimated by prediction, i.e. by evaluating the similarity measure only for a limited number of so-called candidate vectors associated to blocks in the neighboring area of the current block.

U.S. Pat. No. 5,072,293 discloses such a BMA, where predictions from a 3D neighborhood are used as candidate vectors for motion vector estimation. The set of candidate motion vectors comprises both spatial (2D) and temporal (1D) predictions of motion vectors, the best of which is determined for each block recursively. The technique is recursive in that at least one candidate motion vector in the set of candidate motion vectors for a block in the current image n depends on already determined motion vectors of other blocks in the image n (spatial predictions) or in the preceding image n-1 (temporal predictions). This recursive estimation technique implicitly assumes that objects are larger than a block, so that the motion vector can be found in at least one of the spatial predictions from neighboring blocks. Furthermore, inertia of objects is assumed, enabling the estimation technique to use temporal predictions as well, which is especially helpful when no spatial predictions are available yet due to causality. Based on both assumptions, previously found motion vectors are thus recursively optimized.

In recursive BMAs, the composition of the set of candidate vectors for a block, for which the similarity measure has to be evaluated in each recursion step, determines the accuracy and convergence speed of the recursive motion estimation technique, but also its computational complexity. To assure accurate motion vector estimation, a large set of candidate motion vectors has to be chosen, which leads to an increased computational complexity.

It is thus the object of the invention to provide a recursive method for accurate estimation of local vectors with reduced complexity and fast convergence.

To solve the object of the invention it is proposed that the method for recursively estimating local vectors from at least one picture taken from an image sequence comprises the steps of generating a first set of candidate vectors under at least partial use of recursion, selecting candidate vectors from the first set of candidate vectors according to a first criterion to form a smaller second set of candidate vectors, evaluating the candidate vectors of the second set of candidate vectors for a group of pixels based on a second criterion, determining the best vectors from the second set of candidate vectors according to said second criterion and assigning said determined best vectors to a group of pixels that is related to the group of pixels the candidate vectors of the second set of candidate vectors were evaluated for.

By reducing the size of the first set of candidate vectors according to the first criterion, the similarity measure according to the second criterion has to be evaluated for less candidate vectors, so that the computational complexity can be vastly decreased as compared to state-of-the-art estimators, where the similarity measure has to be evaluated for all candidate vectors of the first set of candidate vectors. The first criterion has a low computational complexity as compared to the second criterion and controls both accuracy and convergence of the estimator. The great advantage of the proposed method is that a large first set of candidate vectors can be used, while the pre-selection method picks the most promising from that set for the actual evaluation of the similarity measure. The results require hardly more calculations than necessary for an identical state-of-the-art local vector estimator with a reduced first set of candidate vectors, but the chances of having promising candidates amongst the vectors for which the similarity measure is evaluated have significantly increased.

A further advantage of the method becomes clear when considering a dedicated hardware implementation. Such an implementation often cannot profit from an operations count which is low on the average. It has to be designed for the worst case situation. Now, with a limited first set of candidate vectors, there is a good chance that the number of actually different candidate vectors is lower than the capacity of the hardware. With a larger first set followed by a pre-selection module as proposed in this invention this chance can be much decreased. This leads to a more optimal use of the capacity of the hardware.

Optionally the second set of candidate motion vectors is extended with candidate motion vectors which are not comprised by the first set of motion vectors. E.g. the null-vector, i.e. no motion, is added or a candidate motion vector which is based on the median of the selected motion vectors of the first set of motion vectors.

The candidate vectors in the first set of candidate vectors are preferably spatially and/or temporally predicted based on already determined estimated local vectors and/or the zero vector and/or update vectors, which are either random vectors or belong to a limited fixed set of update vectors. Assuming that objects in a picture of an image sequence are larger than a block and have inertia, local vectors of a current block are quite likely to be similar to already determined local vectors in other neighboring blocks of the current picture around the current block (spatial predictions) or to already determined local vectors of neighboring blocks in the previous image (temporal predictions). The zero vector as candidate vector is particularly helpful for picture parts without motion, whereas the addition of update vectors to spatially and/or temporally predicted local vectors solves the problem that in the initialization phase, all local vectors on which the prediction could be based are zero.

According to the invention, the local vectors preferably represent motion vectors that describe the motion of groups of pixels in pictures of an image sequence.

At least one of said motion vectors may be predicted according to a parametric 2D global motion model. For instance, expressing a motion vector as 2D first-order equation, camera motion such as panning, tilting, travelling and zooming can be precisely modeled. This type of motion has a regular character, causing smooth motion vectors as compared to object motion. Whereas zooming generates motion vectors that linearly change with the spatial position, panning, tilting and travelling generate a uniform motion vector for the entire picture. If such global motion occurs, it can be more efficient to estimate the parameters of the parametric 2D global motion model instead of the motion vectors themselves.

The local vectors can also represent sets of parameters that describe the motion model of a group of pixels in pictures of an image sequence.

As a further alternative, the local vectors may represent spatial features of a group of pixels, in particular texture, dynamic range, color, or average value.

According to the invention, the second criterion can be implemented as a match error criterion such as the Sum of Absolute Differences (SAD) criterion, or as the Mean Square Error (MSE) criterion. In the context of motion vector estimation, then the SAD or MSE between pixels or groups of pixels of the predicted and the current image is calculated. In contrast, in the context of image segmentation, where the components of the local vectors represent spatial features such as texture, dynamic range, color, or average luminance value of an image segment, the SAD and MSE criteria are directly applied to the components of the local vectors and the corresponding spatial features that are measured from the local image content.

The selection of candidate vectors from the first set of candidate vectors to form a smaller second set of candidate vectors is suitably based on a ranking of the corresponding vector components of the candidate vectors in the first set of candidate vectors.

The selection of candidate vectors from the first set of candidate vectors to form a smaller second set of candidate vectors can also be based on a ranking of the candidate vectors in the first set of candidate vectors.

In a preferred embodiment of the invention, the second set of candidate vectors contains at least one extreme and/or one least extreme candidate vector of the first set of candidate vectors according to the first criterion.

As the least extreme candidate vector is often a good one in the converged situation, while the more extreme vectors are particularly helpful in the un-converged situation, it makes sense to select only these for evaluation with the subsequent, computationally more expensive, second criterion. Adding the zero vector (indicating no motion) as an extreme vector also makes sense, as the interpolation of stationary picture parts is critical in many applications of motion vectors.

The extreme candidate vectors are preferably the two vectors with the largest distance to the average vector of a number of candidate vectors of the first set of candidate vectors or with the largest distance to a spatial prediction vector in the first set of candidate vectors, or the longest and the shortest vector, or the largest distance to the rest of the candidate vectors of the first set of candidate vectors.

The least extreme candidate vector is preferably the vector with the smallest distance to the average vector of a number of candidate vectors of the first set of candidate vectors or with the smallest distance to a spatial prediction vector in the first set of candidate vectors, or the vector median.

A further preferred embodiment of the invention is a device for recursively estimating local vectors from at least one picture taken from an image sequence, consisting of means to generate a first set of candidate vectors under at least partial use of recursion, means to select candidate vectors from the first set of candidate vectors according to a first criterion to form a smaller second set of candidate vectors, means to evaluate the candidate vectors of the second set of candidate vectors for a group of pixels based on a second criterion, means to determine the best vectors from the second set of candidate vectors according to said second criterion and means to assign said determined best vectors to a group of pixels that is related to the group of pixels the candidate vectors of the second set of candidate vectors were evaluated for.

A last preferred embodiment of the present invention is a computer program product directly loadable into the internal memory of a digital computer, comprising software code portions for performing the steps of generating a first set of candidate vectors under at least partial use of recursion, selecting candidate vectors from the first set of candidate vectors according to a first criterion to form a smaller second set of candidate vectors, evaluating the candidate vectors of the second set of candidate vectors for a group of pixels based on a second criterion, determining the best vectors from the second set of candidate vectors according to said second criterion and assigning said determined best vectors to a group of pixels that is related to the group of pixels the candidate vectors of the second set of candidate vectors were evaluated for, when said product is run on a computer.

These and other aspects of the invention will be apparent from and elucidated with reference to the embodiments described hereinafter. In the figures show:

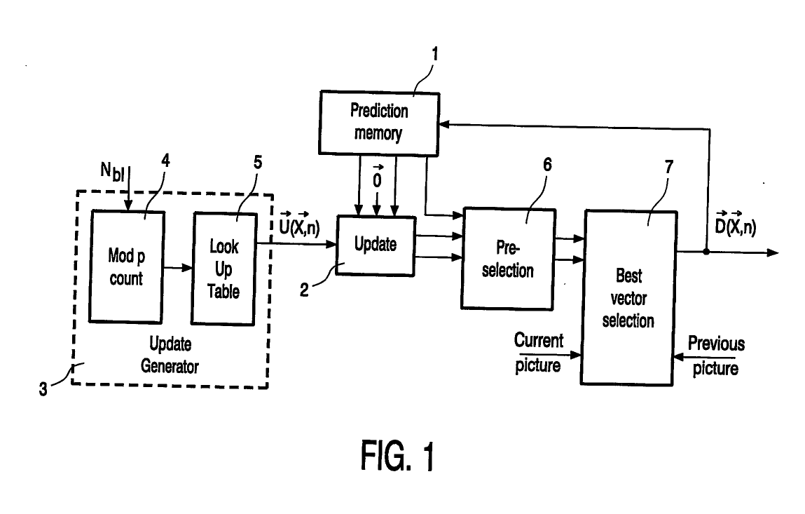

FIG. 1: a first embodiment of a recursive BMA according to the invention, where motion vectors are estimated as local vectors, and

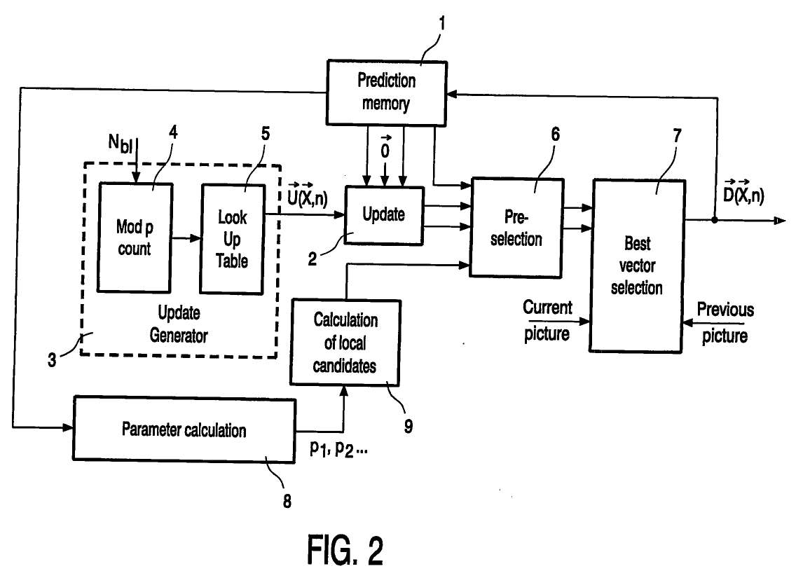

FIG. 2: a second embodiment of a recursive BMA according to the invention, where the estimation of motion vectors as local vectors is enhanced by integrating a candidate motion vector that is predicted according to a global motion model.

FIG. 1 shows a recursive BMA for the estimation of motion vectors according to a first embodiment of the invention.

Let \vec{D}(n) denote the field of motion vectors between the current image I(\vec{x},n) and the previous image I(\vec{x},n−1) of an image sequence, where \vec{x}=[x,y]^{T} is the pixel grid vector. Further let \vec{D}(\vec{X},n)∈ \vec{D}(n) indicate the motion vector assigned to an X×Y block B(\vec{X}) of pixels in the current image I(\vec{x},n), where the center of the block is identified by the block grid vector \vec{X}=[Xₓ,X_{y}]^{T}.

As shown in FIG. 1, the prediction memory instance 1 outputs a set of candidate vectors

$$CS ( \vec{X} , n ) = \{ \vec{C} ∈ {C}^{max} \vert \vec{C} = \vec{D} ( \vec{X} + ( \begin{matrix}kX \\ - Y\end{matrix} ) , n ) ⋁ \vec{C} = \vec{D} ( \vec{X} + ( \begin{matrix}- X \\ 0\end{matrix} ) , n ) ⋁ \vec{C} = \vec{D} ( \vec{X} + ( \begin{matrix}iX \\ jY\end{matrix} ) , n - 1 ) \}$$

$$k = - 1 , 0 , 1 ; i = - 1 , 0 , 1 ; j = 0 , 1 ,$$

where the candidate vectors \vec{C}=[Cₓ,C_{y}]^{T} are limited to the discrete candidate set
CS^{max}={\vec{C}|−N≦Cₓ≦N,−M≦C_{y}≦M },
with constant, pre-defined integers N and M.

Note that there exists a variety of different choices on the composition of the set of candidate vectors CS(\vec{X},n) and the updating procedure presented in the sequel of the description of this preferred embodiment. This specific embodiment, which assumes that blocks in a picture are scanned from top left to bottom right and assumes temporal and/or spatial consistency, thus should only be regarded as an example for a much more general local vector estimation principle.

Either of the 4 spatial candidate vectors of the presented set of candidate vectors CS(\vec{X},n), i.e. the vectors that depend only on the index k or are independent of all indices i, j, k, is then fed to the update instance 2, where an update vector \vec{U}(\vec{X},n) is added. Adding an update vector to one of the spatial candidate vectors contained in CS(\vec{X},n) solves the problem that in the initialization phase of the recursion, all vectors equal the \vec{0} vector. Update vectors can either be generated as noise vectors, or, simpler, be taken from a limited fixed update set stored in a look-up-table, such as
USᵢ(\vec{X},n)={\vec{0},\vec{y}ᵤ,−\vec{y}ᵤ,\vec{x}ᵤ,−\vec{x}ᵤ,2\vec{y}ᵤ,−2\vec{y}ᵤ,3\vec{xx}ᵤ,−3\vec{x}ᵤ},
if pixel resolution with integer update values is desired, or such as
US_{f}(\vec{X},n)={¼\vec{y}ᵤ,−¼\vec{y}ₙ,¼\vec{x}ᵤ,−¼\vec{x}ᵤ}
for quarter pixel resolution with fractional update values.

In this context, \vec{x}ᵤ=[1,0]^{T} and \vec{y}ᵤ=[0,1]_{T} denote the 2D orthonormal basis vectors.

As shown in FIG. 1, an update generator instance 3 consisting of a modulo-p-counter 4 and a look-up-table 5 outputs the required update vectors \vec{U}(\vec{X},n), which are cyclic in p, from the set of update values. The modulo-p-counter is triggered by the current block count N_{b1}. Furthermore, the integer p can be chosen to be no factor of the number of blocks in a picture, so that a coupling between update vector and spatial position within the image is prevented.

The temporal candidate vectors as output from the prediction memory instance 1 and the spatial candidate vectors, either of which has been updated in the update instance 2, are input into the pre-selection instance 6. The pre-selection instance performs a ranking of the candidate vectors \vec{C} contained in the set CS(\vec{X},n), e.g. by determining the distance of all candidate vectors to the average vector of all candidate vectors in the set CS(\vec{X},n). As an alternative, the candidate vectors are sorted by length (magnitude). The pre-selection instance 6 then determines two extreme candidate vectors according to the ranking, e.g. the two vectors with the largest distance to the average vector or the longest and the smallest vectors. The pre-selection instance 6 also determines the least extreme of the candidate vectors \vec{C}, e.g. the vector with the smallest distance to the average vector. Alternatively, the median vector can be determined as least extreme vector. The most and least extreme vectors as determined by the pre-selection instance 6 constitute the set CS_{red}(\vec{X},n), which is forwarded to the best vector selection instance 7. In this exemplary set-up, the set of candidate vectors CS(\vec{X},n) comprising 10 candidate vectors is thus reduced to a set of 3 most/least extreme candidate vectors contained in CS_{red}(\vec{X},n).

The best vector selection instance 7 as depicted in FIG. 1 determines the similarity between the considered block B(\vec{X}) centered at block grid vector \vec{X} in the current image I(\vec{x},n) and the block in the previous image I(\vec{x},n−1) associated to each candidate vector in the set CS_{red}(\vec{X},n) by computing the similarity measure (e.g. the Sum of Absolute Differences, SAD):

$$ɛ ( \vec{C} , \vec{X} , n ) = {\sum }_{\vec{x} ∈ B ( \vec{X} )} \vert I ( \vec{x} , n ) - I ( \vec{x} - \vec{C} , n - 1 ) \vert + α ‖ \vec{U} ( \vec{X} , n ) ‖ ,$$

where ∥\vec{U}(\vec{X},n)∥ is the length of the update vector, α is a constant, and the matching error is summed over a block \vec{B}(\vec{X}), at position \vec{X}=[Xₓ,X_{y}]^{T} of the block grid with a width X and height Y, defined as
B(\vec{X})={\vec{x}|Xₓ−X/2≦x≦Xₓ+X/2, X_{y}−Y/2≦y≦X_{y}+Y/2}.
Alternatively, a different similarity measure such as the Mean Square Error (MSE) can be applied as second criterion as well. Note that, instead of evaluating the similarity measure for all pixels \vec{x}=[x,y]^{T} on the pixel grid within the block B(\vec{X}), spatial sub-sampling in both x- and y-direction can be performed before evaluating the similarity measure to reduce the number of computations, where, of course, some accuracy is lost.

Irrespective of the applied second criterion and sampling technique, the best vector selection instance 7 further selects the candidate motion vector leading to the largest similarity measure:
\vec{D}(\vec{X},n)={\vec{C}∈CS_{red}(\vec{X},n|ε(\vec{C},\vec{X},n)<ε(\vec{V},\vec{X},n)}∀{\vec{V}∈CS_{red}(\vec{X+EE,n}
and assigns this best candidate motion vector to all pixels at positions \vec{x}=[x,y]^{T} on the pixel grid within the block B(\vec{X}) (even if spatial sub-sampling was performed to reduce the computational effort in evaluating the similarity measure).

The best motion vector \vec{D}(\vec{X},n) then is output as result of the motion estimation for block B(\vec{X}), but also stored in the prediction memory instance 7 for use in subsequent recursion steps.

FIG. 2 shows a second preferred embodiment of the present invention, where motion vectors are estimated as local vectors and where the recursive estimation is enhanced by integrating a candidate motion vector that is predicted according to a global motion model.

Basically, the set up of FIG. 2 evolves from the set-up of FIG. 1, in that the set-up of FIG. 2 comprises a prediction memory instance 1, an update instance 2, an update generator instance 3, composed of a mod-p-count 4 and a look-up-table 5, a pre-selection instance 6 and a best vector selection instance 7.

As in the first preferred embodiment of the invention shown in FIG. 1, a first set of candidate motion vectors CS(\vec{X},n) is spatially and temporally predicted by the prediction memory instance 1 and input to the pre-selection instance 6, where either of the spatial candidates is previously updated in the update instance 2 with cyclic update vectors \vec{U}(\vec{X},n) that are generated by the update generator instance 3. The most/least extreme candidate vectors CS_{red}(\vec{X},n) as determined by the pre-selection instance 6 are then subject to evaluation with the similarity measure in the best vector selection instance 7, where the best motion vector \vec{D}(\vec{X},n) for the block B(\vec{X}) is determined and stored in the prediction memory 1 for the next recursion step.

However, the second preferred embodiment depicted in FIG. 2 differs from the first preferred embodiment shown in FIG. 1 in that the first set of candidate vectors additionally contains a candidate motion vector that can be described with a 2D first-order linear equation with three parameters p₁(n),p₂(n) and p₃(n) according to

$${\vec{D}}_{g} ( \vec{X} , n ) = ( \begin{matrix}{p}_{1} ( n ) + {p}_{3} ( n ) x \\ {p}_{2} ( n ) + {p}_{3} ( n ) y\end{matrix} ) ,$$

where p₁(n) describes panning, p₂(n) describes tilting and p₃(n) describes zooming of the camera. This global motion vector model thus assumes that motion has a very regular character causing very smooth velocities, i.e. motion vectors. Zooming with the camera will generate motion vectors that linearly change with the spatial position. Panning, tilting or travelling with a camera, on the other hand, will generate a uniform motion vector for the entire screen. Extending the model to a six parameter model additionally enables the description of vector fields due to rotations. This type of motion is not very likely due to camera motion, but can occur in other circumstances.

According to FIG. 2, the parameters of the motion model p₁(n),p₂(n) and p₃(n) are e.g. determined by a micro processor 8 based on sample vectors from the prediction memory 1. There are many options to extract these parameters of a global motion model from an estimated motion vector field. In the present preferred embodiment where the model is integrated in the recursive BMA, it makes sense to start from already available motion vectors, i.e. the vectors available in the temporal prediction memory. To keep the operations count low, it is furthermore attractive to use a limited set of the vectors available in this memory only.

The estimated parameters of the motion model p₁(n), p₂(n) and p₃(n) are then put into the local candidate calculation instance 9, where the motion vector \vec{D}_{g}(\vec{X},n) is constructed and subsequently, without updating, put into the pre-selection instance 6, together with the spatial (some of which may be updated) and temporal predictions from the prediction memory instance 1.

1. Method for recursively estimating local vectors from at least one picture taken from an image sequence, comprising the steps of
generating a first set of candidate vectors under at least partial use of recursion,
selecting candidate vectors from the first set of candidate vectors according to a first criterion to form a smaller second set of candidate vectors,
evaluating the candidate vectors of the second set of candidate vectors for a group of pixels based on a second criterion,
determining the best vectors from the second set of candidate vectors according to said second criterion and
assigning said determined best vectors to a group of pixels that is related to the group of pixels the candidate vectors of the second set of candidate vectors were evaluated for.

2. Method according to claim 1, characterized in that the candidate vectors in said first set of candidate vectors are spatially and/or temporally predicted based on already determined estimated local vectors and/or the zero vector and/or update vectors, which are either random vectors or belong to a limited fixed set of update vectors.

3. Method according to claim 1, characterized in that the local vectors are motion vectors that describe the motion of groups of pixels in pictures of an image sequence.

4. Method according to claim 3, characterized in that at least one of said motion vectors is predicted according to a parametric 2D global motion model.

5. Method according to claim 1, characterized in that the local vectors represent sets of parameters that describe the motion model of a group of pixels in pictures of an image sequence.

6. Method according to claim 1, characterized in that the local vectors represent spatial features of a group of pixels, in particular texture, dynamic range, color or average value.

7. Method according to claim 1, characterized in that the second criterion is a match error criterion such as the Sum of Absolute Differences (SAD) criterion, or a mean square error criterion.

8. Method according to claim 1, characterized in that the selection of candidate vectors from the first set of candidate vectors to form a smaller second set of candidate vectors is based on a ranking of the corresponding vector components of the candidate vectors in the first set of candidate vectors.

9. Method according to claim 1, characterized in that the selection of candidate vectors from the first set of candidate vectors to form a smaller second set of candidate vectors is based on a ranking of the candidate vectors in the first set of candidate vectors.

10. Method according to claim 1, characterized in that the second set of candidate vectors contains at least one extreme and/or one least extreme candidate vector of the first set of candidate vectors according to the first criterion.

11. Method according to claim 10, characterized in that the extreme candidate vectors are the two vectors with the largest distance to the average vector of a number of candidate vectors of the first set of candidate vectors or with the largest distance to a spatial prediction vector in the first set of candidate vectors, or the longest and the shortest vector, or the largest distance to the rest of the candidate vectors of the first set of candidate vectors.

12. Method according to claim 10, characterized in that the least extreme candidate vector is the vector with the smallest distance to the average vector of a number of candidate vectors of the first set of candidate vectors or with the smallest distance to a spatial prediction vector in the first set of candidate vectors, or the vector median.

13. Device for recursively estimating local vectors from at least one picture taken from an image sequence, consisting of:
means to generate a first set of candidate vectors under at least partial use of recursion,
means to select candidate vectors from the first set of candidate vectors according to a first criterion to form a smaller second set of candidate vectors,
means to evaluate the candidate vectors of the second set of candidate vectors for a group of pixels based on a second criterion,
means to determine the best vectors from the second set of candidate vectors according to said second criterion and
means to assign said determined best vectors to a group of pixels that is related to the group of pixels the candidate vectors of the second set of candidate vectors were evaluated for.

14. A computer program product directly loadable into the internal memory of a digital computer, comprising software code portions for performing the steps of claim 1 when said product is run on a computer.
